(19) United States
(12) Patent Application Publication
(10) Pub. No.: US 2025/0364636 A1
(43) Pub. Date: Nov. 27, 2025

(54) POWER STORAGE DEVICE

(71) Applicant: TOYOTA JIDOSHA KABUSHIKI KAISHA, Toyota-shi Aichi-ken (JP)

(72) Inventors: Akio UOTANI, Nagoya-shi Aichi-ken (JP); Dexu ZHANG, Mishima-shi Shizuoka-ken (JP); Yoshinobu KUROYAMA, Aichi-gun Aichi-ken (JP); Daisuke KAMESAKI, Okazaki-shi Aichi-ken (JP); Seigo FUJISHIMA, Miyoshi-shi Aichi-ken (JP); Yuki TAKAHASHI, Miyoshi-shi Aichi-ken (JP)

(73) Assignee: TOYOTA JIDOSHA KABUSHIKI KAISHA, Toyota-shi Aichi-ken (JP)

(21) Appl. No.: 19/088,409

(22) Filed: Mar. 24, 2025

(30) Foreign Application Priority Data
May 27, 2024 (JP) 2024-085310

(51) Int. Cl. H01M 10/658; B60L 50/64; H01M 50/209; H01M 50/291; H01M 50/293; H01M 50/358

(52) U.S. Cl. CPC H01M 10/658; H01M 50/209; H01M 50/291; H01M 50/293; H01M 50/358; B60L 50/64; H01M 2220/20

(57) ABSTRACT

A power storage device includes a housing case including a first side wall portion, a second side wall portion, a first inner wall portion, and a second inner wall portion, and a first power storage stack, a second power storage stack, and a third power storage stack disposed between the first side wall portion and the first inner wall portion, between the first inner wall portion and the second inner wall portion, and between the second inner wall portion and the second side wall portion, respectively. The first and second inner wall portions have a first inner side surface and a first outer side surface, the first and second side wall portions have a second inner side surface, and on the first and second inner side surfaces, an opening communicating with an exhaust path is provided more than the first outer side surface.

### CROSS-REFERENCE TO RELATED APPLICATION

This application claims priority to Japanese Patent Application No. 2024-085310 filed on May 27, 2024, incorporated herein by reference in its entirety.

### BACKGROUND

### 1. Technical Field

The present disclosure relates to a power storage device mounted on a vehicle.

### 2. Description of Related Art

WO 2020/134054 discloses, as a conventional power storage device, a structure in which a part of a housing case that houses a plurality of power storage stacks is formed of a hollow member, and a hollow portion of the hollow member is used as an exhaust path. The hollow member is provided with a plurality of through holes that allows introduction of a gas discharged from the power storage device.

### SUMMARY

When arranging the power storage stacks in the housing case, it is conceivable to arrange three power storage stacks side by side, and define respective regions in which the power storage stacks are to be arranged using wall portions in which an exhaust path is provided. In this case, when no measures are taken, there is a fear that when one of the three power storage stacks generates heat, the heat is transferred to the other power storage stacks arranged side by side to cause the power storage stacks to generate heat in a chain manner.

The present disclosure has been made in view of the above issue. An object of the present disclosure is to provide a power storage device capable of suppressing, when one of three power storage stacks arranged side by side generates heat, the transfer of the heat to the other power storage stacks that are adjacent in the lateral direction.

An aspect of the present disclosure provides a power storage device including:
a first power storage stack, a second power storage stack, and a third power storage stack arranged in a first direction; and
a housing case that houses the first power storage stack, the second power storage stack, and the third power storage stack.
   The housing case includes a pair of side wall portions and a pair of inner wall portions, the side wall portions being each located on an end portion side in the first direction, and the inner wall portions being disposed between the side wall portions.
   An exhaust path is provided inside each of the side wall portions and the inner wall portions.
   The side wall portions include a first side wall portion located on one side in the first direction and a second side wall portion located on another side in the first direction.
   The inner wall portions include a first inner wall portion located on the one side in the first direction and a second inner wall portion located on the other side in the first direction.
   The first power storage stack is disposed between the first side wall portion and the first inner wall portion.
   The second power storage stack is disposed between the inner wall portions.
   The third power storage stack is disposed between the second inner wall portion and the second side wall portion.
   The first inner wall portion and the second inner wall portion have respective first inner side surfaces that face each other in the first direction and respective first outer side surfaces each located on a side opposite to a side where the first inner side surface is located in the first direction.
   Each of the first side wall portion and the second side wall portion has a second inner side surface that faces the side wall portions in the first direction.
   An opening portion that communicates with the exhaust path is provided in the first inner side surface of each of the first inner wall portion and the second inner wall portion and in the second inner side surface of each of the first side wall portion and the second side wall portion in which the number of the opening portions is greater than the number of opening portions provided in each of the first outer side surfaces.

According to the above configuration, when the gas is discharged from the first power storage stack or the third power storage stack, the ratio of the gas discharged from the side wall portions is higher than the ratio of the gas discharged from the inner wall portions, and thus the heat is less likely to be transferred to the inner wall portions. Accordingly, it is possible to suppress heat being transferred to the second power storage stack disposed between the inner wall portions. When the gas is discharged from the second power storage stack, the gas passes through the inside of each of the inner wall portions in a distributed manner, and thus it is possible to suppress heat being transferred to the first power storage stack and the third power storage stack.

In the power storage device according to the aspect of the present disclosure, a heat insulating member may be provided on the first outer side surface of each of the first inner wall portion and the second inner wall portion.

According to the above configuration, it is possible to effectively suppress the transfer of heat to the first power storage stack and the third power storage stack by the heat insulating member when the gas is discharged from the second power storage stack. Similarly, it is possible to effectively suppress the transfer of heat to the second power storage stack by the heat insulating member when the gas is discharged from the first power storage stack or the third power storage stack.

In the power storage device according to the aspect of the present disclosure, each of the first inner wall portion and the second inner wall portion may have an inner end portion located on a side of the first inner side surface in the first direction and an outer end portion located on a side of the first outer side surface.

In the first inner wall portion and the second inner wall portion, the exhaust path may be located between the inner end portion and the outer end portion.
In this case, a thickness of the outer end portion in the first direction may be greater than a thickness of the inner end portion in the first direction.

According to the above configuration, with the thicker outer end portion positioned as defined in the above thickness relationship, it is possible to further suppress the transfer of heat to the first power storage stack and the third power storage stack when the gas is discharged from the second power storage stack. Similarly, it is possible to further suppress the transfer of heat to the second power storage stack when the gas is discharged from the first power storage stack or the third power storage stack.

According to the present disclosure, it is possible to provide a power storage device including three power storage stacks arranged side by side, the power storage device being capable of suppressing, when one of the power storage stacks generates heat, the transfer of heat to the other power storage stacks that are adjacent in the lateral direction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle according to an embodiment;

FIG. 2 is a schematic cross-sectional view showing a state in which the power storage device according to the embodiment is mounted on a vehicle body; and

FIG. 3 is an exploded perspective view of the power storage device according to the embodiment.

### DETAILED DESCRIPTION OF EMBODIMENTS

Hereinafter, embodiments of the present disclosure will be described in detail with reference to the drawings. In the following embodiments, the same or common parts are denoted by the same reference numerals in the drawings, and the description thereof will not be repeated.

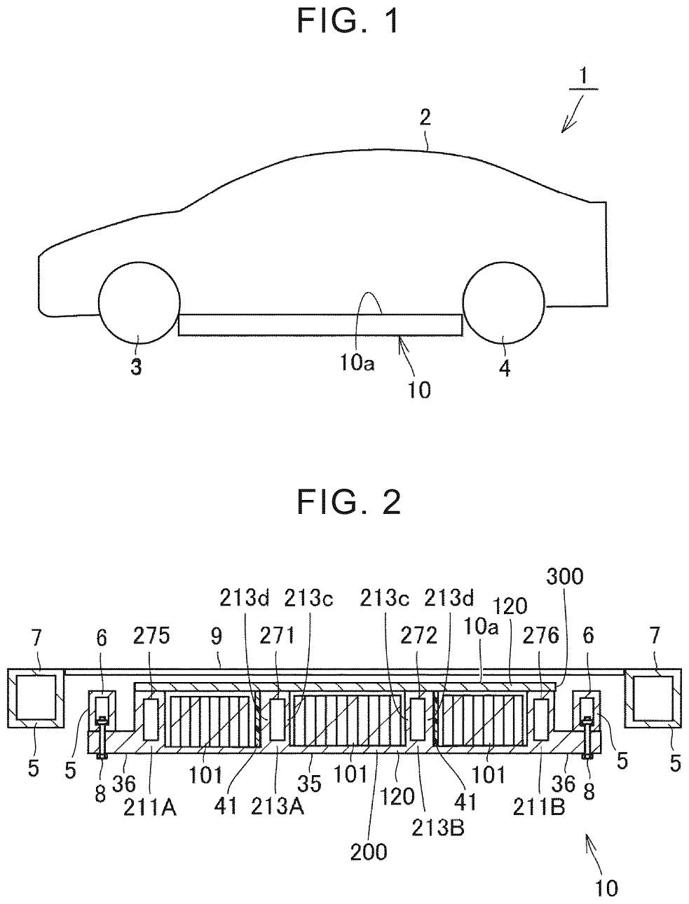

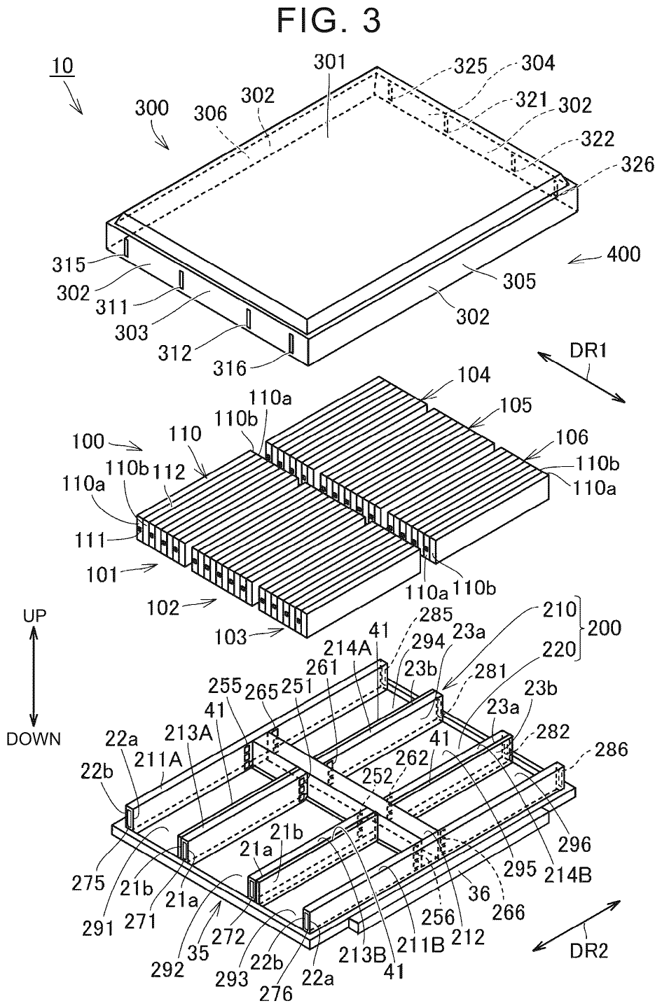

FIG. 1 is a schematic diagram illustrating a vehicle according to an embodiment. FIG. 2 is a schematic cross-sectional view illustrating a state in which the power storage device according to the embodiment is mounted on a vehicle body. Referring to FIGS. 1 and 2, a vehicle 1 according to an embodiment will be described.

The vehicle 1 is a hybrid electric vehicle that can travel by using power of at least one of a motor and an engine, or an electrified vehicle that travels by a driving force obtained by electric energy.

As illustrated in FIG. 1, the vehicle 1 includes a vehicle body 2, a front wheel 3, a rear wheel 4, and a power storage device 10. The vehicle body 2 includes a frame member 5. The power storage device 10 is disposed on the lower side of the vehicle body 2. The power storage device 10 is disposed, for example, between the front wheel 3 and the rear wheel 4. Note that a part of the power storage device 10 may be disposed so as to overlap at least one of the front wheel 3 and the rear wheel 4 when viewed from the width direction of the vehicle 1. The power storage device 10 has an upper surface 10a. The upper surface 10a may function as a floor member defining the interior of the vehicle.

The frame member 5 includes a pair of side members 6 and a pair of side sills 7. The pair of side sills 7 are disposed on both end sides in the width direction of the vehicle 1. The pair of side members 6 are disposed inside the pair of side sills 7 at a distance. The pair of side members 6 and the pair of side sills 7 extend along the front-rear direction of the vehicle 1.

The pair of side members 6 are spaced apart in the width direction of the vehicle 1. A main body portion 35 of the power storage device 10 is disposed in a gap between the pair of side members 6. A gap is provided between the main body portion 35 and the pair of side members 6. Thus, even when the vehicle 1 collides laterally, it is possible to prevent an impact from being input to the power storage device 10.

The fixed portions 36 are provided on both side surfaces of the main body portion 35 in the width direction of the vehicle 1. The fixed portion 36 is fixed to the pair of side members 6 by the fastening member 8.

The frame member 5 also includes a cross frame member 9. The cross frame member 9 extends from one side sill 7 to the other side sill 7 above the power storage device 10. An upper surface 10a of the power storage device 10 is fixed to the cross frame member 9.

In the above description, a case in which the frame member 5 includes the pair of side members 6 and the pair of side sills 7 has been described as an example, but the present disclosure is not limited thereto. The pair of side sills 7 may also have the function of the pair of side members 6. In this case, the pair of side members 6 may be omitted, and the fixed portion 36 may be fixed to the pair of side sills 7.

FIG. 3 is a schematic exploded perspective view of a power storage device according to a first embodiment. A detailed structure of the power storage device 10 will be described with reference to FIGS. 2 and 3 described above.

As illustrated in FIGS. 2 and 3, the power storage device 10 includes a plurality of heat insulating members 41, a power storage module 100, and a housing case 120. The power storage module 100 is housed in the housing case 120.

The power storage module 100 includes a plurality of power storage stacks 101 to 106. The plurality of power storage stacks 101 to 106 are arranged in a matrix in the housing case 120. When the first direction (DR1) is a row direction and the second direction (DR2) is a column direction, the plurality of power storage stacks 101 to 106 are arranged in three rows and two columns.

The first direction is, for example, parallel to the width direction of the vehicle 1 in a mounted state in which the power storage device 10 is mounted on the vehicle body 2. The second direction is orthogonal to the first direction and is parallel to the front-rear direction of the vehicle 1 in the mounted state. The plurality of power storage stacks 101 to 106 are electrically connected in series.

Each of the power storage stacks 101 to 106 includes a plurality of unit cells 110. In each of the power storage stacks 101 to 106, the plurality of unit cells 110 are arranged in the first direction. The plurality of unit cells 110 are electrically connected in series.

The unit cell 110 has a longitudinal shape in which the second direction is a longitudinal direction. The unit cell 110 has a flat rectangular parallelepiped shape having a thickness in the first direction.

The unit cell 110 includes a housing 112, and one or a plurality of electrode bodies are accommodated in the housing 112.

When a single electrode body is accommodated in the housing 112, the electrode body has a shape extending in the longitudinal direction. The electrode body may be a laminated electrode body in which a negative electrode sheet, a separator, and a positive electrode sheet are laminated, or may be a wound electrode body in which a negative electrode sheet, a separator, and a positive electrode sheet are wound.

When a plurality of electrode bodies are accommodated in the housing 112, the plurality of electrode bodies are arranged side by side in the longitudinal direction and are connected in series. Also in this case, the electrode body may be a laminated electrode body or a wound electrode body.

The unit cell 110 is a secondary battery such as a nickel metal hydride battery or a lithium-ion battery. The unit cell 110 may be a liquid electrolyte or a solid electrolyte. The unit cell 110 may be a chargeable/dischargeable capacitor.

The housing 112 is made of, for example, a metal material such as aluminum. The housing 112 includes a first end face 110a, a second end face 110b, and an exhaust valve 111 arranged in the second direction. The exhaust valve 111 is formed on the first end face 110a. The exhaust valve 111 opens when the internal pressure of the housing 112 exceeds a predetermined value, and discharges the gas in the housing 112 to the outside of the housing 112.

In each of the power storage stacks 101 to 106, in the plurality of unit cells 110 arranged in the first direction, the exhaust valves 111 are alternately positioned on one side in the second direction and the other side in the second direction. That is, in each of the one side and the other side in the second direction, the plurality of unit cells 110 are arranged in the first direction with the first end face 110a and the second end face 110b alternately arranged in the first direction.

The housing case 120 includes an upper member 300 and a lower case 200. The upper member 300 has, for example, a substantially box-shaped shape that opens downward. The upper member 300 includes a top plate 301 and a peripheral wall 302. The peripheral wall 302 extends downward from an outer peripheral edge portion of the top plate 301. The peripheral wall 302 includes end walls 303 and 304 arranged in the second direction, and side walls 305 and 306 arranged in the first direction.

The end wall 303 is formed with an external discharge port 311, 312, 315, 316 that penetrates the end wall 303. Further, the end wall 304 is formed with an external discharge port 321, 322, 325, 326 that penetrates the end wall 304.

The lower case 200 includes a plurality of wall portions 210 and a bottom plate 220. The plurality of wall portions 210 are provided on the upper surface of the bottom plate 220. The lower case 200 includes a main body portion 35 and a fixed portion 36. The main body portion 35 includes a plurality of wall portions 210 and a bottom plate 220. The fixed portions 36 are provided on both side surfaces of the main body portion 35 in the second direction.

The plurality of wall portions 210 includes a pair of side wall portions 211A, 211B, a partition wall portion 212, a pair of inner wall portions 213A, 213B, and a pair of inner wall portions 214A, 214B. The pair of side wall portions 211A, 211B, the partition wall portion 212, the pair of inner wall portions 213A, 213B, and the pair of inner wall portions 214A, 214B stand up from the bottom plate 220.

The pair of side wall portions 211A, 211B, the pair of inner wall portions 213A, 213B, and the pair of inner wall portions 214A, 214B extend in the second direction. A pair of side wall portions 211A, 211B, a pair of inner wall portions 213A, 213B, and a pair of inner wall portions 214A, 214B are provided with an exhaust path through which gases discharged from the power storage stacks can flow, as will be described later.

The pair of side wall portions 211A, 211B are spaced apart from each other in the first direction. The pair of side wall portions 211A, 211B are disposed on both sides of the bottom plate in the first direction. The side wall portion 211A corresponds to the first side wall portion and is disposed on one side in the first direction. The side wall portion 211B corresponds to the second side wall portion and is disposed on the other side in the first direction.

Each of the side wall portions 211A, 211B has a second inner side surface 22a facing the pair of inner side wall portions 213A, 213B in the first direction, and a second outer side surface 22b facing away from the side where the second inner side surface 22a is located in the first direction.

The partition wall portion 212 extends in the first direction on the upper surface of the bottom plate 220. The partition wall portion 212 is disposed at a substantially central portion of the bottom plate 220 in the second direction. The partition wall portion 212 divides the space in the housing case 120 in the second direction.

The pair of inner wall portions 213A, 213B is disposed in a space on one side in the second direction in the housing case 120 partitioned by the partition wall portion 212. The pair of inner wall portions 213A, 213B are disposed between the pair of side wall portions 211A, 211B on one side in the second direction. The pair of inner wall portions 213A, 213B are spaced apart from the pair of side wall portions 211A, 211B and spaced apart from each other in the first direction. The inner wall portion 213A corresponds to the first inner wall portion and is located on one side in the first direction. The inner wall portion 213B corresponds to the second inner wall portion and is located on the other side in the first direction.

The pair of inner wall portions 213A, 213B divide the space in the housing case 120 located on one side of the partition wall portion 212 in the second direction into three regions (the first region 291, the second region 292, and the third region 293) in the first direction.

A power storage stack 101 (first power storage stack) is disposed between the side wall portion 211A and the inner wall portion 213A in a space in the housing case located on one side in the second direction. A power storage stack 102 (second power storage stack) is disposed between the inner wall portion 213A and the inner wall portion 213B. A power storage stack 103 (third power storage stack) is disposed between the inner wall portion 213B and the side wall portion 211B.

Each of the pair of inner side wall portions 213A, 213B has a first inner side surface 21a facing in the first direction and a first outer side surface 21b located on a side opposite to a side where the first inner side surface 21a is located in the first direction.

Each of the pair of inner wall portions 213A, 213B has an inner end portion 213c located on the first inner side surface 21a side in the first direction and an outer end portion 213d located on the first outer side surface 21b side. The exhaust path 271,272, which will be described later, is located between the inner end portion 213c and the outer end portion 213d of the inner wall portions 213A, 213B.

The thickness of the outer end portion 213d in the first direction is larger than the thickness of the inner end portion 213c in the first direction. The thickness of the outer end portion 213d and the inner end portion 213c is not limited to the above, and the thickness of the outer end portion 213d and the thickness of the inner end portion 213c may be substantially the same.

The pair of inner wall portions 214A, 214B (the third inner wall portion and the fourth inner wall portion) are disposed in the space on the other side in the first direction in the housing case 120 partitioned by the partition wall portion 212. The pair of inner wall portions 214A, 214B is disposed between the pair of side wall portions 211A, 211B. The pair of inner wall portions 214A, 214B are spaced apart from the pair of side wall portions 211A, 211B and spaced apart from each other in the first direction. The inner wall portion 214A is located on one side in the first direction, and the inner wall portion 214B is located on the other side in the first direction.

The pair of inner wall portions 214A, 214B divide the space in the housing case 120 located on the other side of the partition wall portion 212 in the second direction into three regions (the fourth region 294, the fifth region 295, and the sixth region 296) in the first direction.

In the space in the housing case located on the other side in the second direction, a power storage stack 104 (fourth power storage stack) is disposed between the side wall portion 211A and the inner wall portion 214A. A power storage stack 105 (fifth power storage stack) is disposed between the inner wall portion 214A and the inner wall portion 214B. A power storage stack 106 (sixth power storage stack) is disposed between the inner wall portion 214B and the side wall portion 211B.

Each of the pair of inner side wall portions 214A, 214B has a third inner side surface 23a facing in the first direction and a third outer side surface 23b located on a side opposite to a side where the third inner side surface 23a is located in the first direction. Also, in the pair of inner side wall portions 214A, 214B, the thickness of the outer end portion located on the third outer side surface 23b side in the first direction is larger than the thickness of the inner end portion located on the third inner side surface 23a side in the first direction. The thickness relationship between the outer end portion and the inner end portion is not limited to the above, and the thickness of the outer end portion and the thickness of the inner end portion may be substantially the same.

The side wall portion 211A is provided with a plurality of opening portions 255, 265 and an exhaust path 275, 285. The plurality of opening portions 255, 265 are provided on the second inner side surface 22a of the side wall portion 211A.

The plurality of opening portions 255 open toward the first region 291 located between the side wall portion 211A and the inner wall portion 213A. The plurality of opening portions 255 communicate with an exhaust path 275 provided inside the side wall portion 211A. The exhaust path 275 extends from the partition wall portion 212 side toward one side in the second direction. The exhaust path 275 communicates with the external discharge port 315.

The plurality of opening portions 265 open toward the fourth region 294 located between the side wall portion 211A and the inner wall portion 214A. The plurality of opening portions 265 communicate with an exhaust path 285 provided inside the side wall portion 211A. The exhaust path 285 extends from the partition wall portion 212 side toward the other side in the second direction. The exhaust path 285 communicates with the external discharge port 325.

A plurality of opening portions 251, 252 and an exhaust path 271, 272 are provided in the pair of inner wall portions 213A, 213B.

The plurality of opening portions 251 are provided on the first inner side surface 21a of the inner wall portion 213A. The plurality of opening portions 252 are provided on the first inner side surface 21a of the inner wall portion 213B. The plurality of opening portions 251, 252 are open toward the second regions 292 located between the pair of inner wall portions 213A, 213B.

The plurality of opening portions 251 communicate with an exhaust path 271 provided in the inner wall portion 213A. The exhaust path 271 extends from the partition wall portion 212 side toward one side in the second direction. The exhaust path 271 communicates with the external discharge port 311.

The plurality of opening portions 252 communicate with an exhaust path 272 provided in the inner wall portion 213B. The exhaust path 272 extends from the partition wall portion 212 side toward one side in the second direction. The exhaust path 272 communicates with the external discharge port 312.

The side wall portion 211B is provided with a plurality of opening portions 256, 266 and an exhaust path 276, 286. The plurality of opening portions 256, 266 are provided on the second inner side surface 22a of the side wall portion 211B.

The plurality of opening portions 256 open toward the third region 293 located between the side wall portion 211B and the inner wall portion 213B. The plurality of opening portions 256 communicate with an exhaust path 276 provided inside the side wall portion 211B. The exhaust path 276 extends from the partition wall portion 212 side toward one side in the second direction. The exhaust path 276 communicates with the external discharge port 316.

The plurality of opening portions 266 open toward the sixth region 296 located between the side wall portion 211B and the inner wall portion 214B. The plurality of opening portions 266 communicate with an exhaust path 286 provided inside the side wall portion 211B. The exhaust path 286 extends from the partition wall portion 212 side toward the other side in the second direction. The exhaust path 286 communicates with the external discharge port 326.

A plurality of opening portions 261, 262 and an exhaust path 281, 282 are provided in the pair of inner wall portions 214A, 214B.

The plurality of opening portions 261 are provided on the third inner side surface 23a of the inner wall portion 214A. The plurality of opening portions 262 are provided on the third inner side surface 23a of the inner wall portion 214B. The plurality of opening portions 261, 262 are open toward the second regions 292 located between the pair of inner wall portions 214A, 214B.

The plurality of opening portions 261 communicate with an exhaust path 281 provided in the inner wall portion 214A. The exhaust path 281 extends from the partition wall portion 212 side toward the other side in the second direction. The exhaust path 281 communicates with the external discharge port 321.

The plurality of opening portions 262 communicate with an exhaust path 282 provided in the inner wall portion 214B. The exhaust path 282 extends from the partition wall portion 212 side toward the other side in the second direction. The exhaust path 282 communicates with the external discharge port 322.

Each of the plurality of opening portions 251, 252, 255, 256 is provided on one side in the second direction in the housing case 120 partitioned by the partition wall portion 212, on the side close to the partition wall portion 212. Each of the plurality of opening portions 261, 262, 265, 266 is provided on the other side in the second direction in the housing case 120 partitioned by the partition wall portion 212, on the side close to the partition wall portion 212.

Each of the plurality of opening portions 251, 252, 255, 256, 261, 262, 265, 266 includes, for example, three opening portions and is arranged at intervals in the up-down direction. The up-down direction is a direction orthogonal to the first direction and the second direction. Note that each of the plurality of opening portions 251, 252, 255, 256, 261, 262, 265, 266 is not limited to the up-down direction, and may be arranged at intervals in the second direction.

The plurality of heat insulating members 41 are provided on the first outer side surface 21b of each of the pair of inner wall portions 213A, 213B and the third outer side surface 23b of each of the pair of inner wall portions 214A, 214B. Each heat insulating member 41 covers the entire outer side surface.

Here, in the present embodiment, in the housing case, on one side in the second direction partitioned by the partition wall portion 212, the first inner side surface 21a of each, and the second inner side surface 22a of each, the opening portion is provided more than the first outer side surface 21b. Here, each first inner side surface 21a is a first inner side surface 21a of each inner wall 213A, 213B. Each second inner side surface 22a is a second inner side surface 22a of each of the sidewall portions 211A, 211B. The first outer side surface 21b is a first outer side surface 21b of the inner wall 213A, 213B. The opening portion is an opening portion that communicates with the exhaust path.

When the gas is discharged from the power storage stack 101, the number of the plurality of opening portions 255 provided in the second inner side surface 22a of the side wall portion 211A is larger than the number of opening portions provided in the first outer side surface 21b of the inner wall portion 213A. Therefore, the ratio of the gases discharged from the side wall portion 211A to the outside through the exhaust path 275 increases. This makes it difficult for heat to be transferred to the inner wall portion 213A, and in turn, it is possible to prevent heat from being transferred to the power storage stacks 102 located on the pair of inner wall portions 213A, 213B.

Similarly, when the gas is discharged from the power storage stack 103, the ratio of the gas discharged from the side wall portion 211B to the outside through the exhaust path 276 increases. This makes it difficult for heat to be transferred to the inner wall portion 213B, and in turn, it is possible to prevent heat from being transferred to the power storage stacks 102 located on the pair of inner wall portions 213A, 213B.

When the gas is discharged from the power storage stack 102, the gas is dispersed in the exhaust path 271, 272 inside each of the pair of inner wall portions 213A, 213B, and thus the transfer of heat to the power storage stack 101 and the power storage stack 103 can be suppressed.

Note that gas may be discharged from any of the power storage stacks 104, 105, 106. In this case, the gas flow differs only in the exhaust path 285, 281, 282, 286 compared to the case where the gas is discharged from any of the above-described power storage stacks 101, 102, 103. As described above, gas may be discharged from the power storage stack 104 or the power storage stack 106. Therefore, in this case, the transfer of heat to the power storage stack 105 can be suppressed, and in the case where the gas is discharged from the power storage stack 105, the transfer of heat to the power storage stack 104 and the power storage stack 106 can be suppressed.

As described above, in the present embodiment, in the power storage device 10 including the three power storage stacks arranged side by side, it is possible to suppress the transfer of heat to the other power storage stacks adjacent to each other in the lateral direction when any one of the power storage stacks generates heat.

In the present embodiment, the first outer side surface 21b, third outer side surface 23b is not provided with an opening portion. As described above, as long as the number of the plurality of opening portions 251, 252, 255, 256 is larger than the number of the opening portions provided in the first outer side surface 21b, one or more opening portions may be provided in the first outer side surface 21b. Similarly, one or more opening portions may be provided in the third outer side surface 23b as long as the number of the plurality of 261, 262, 265, 266 is greater than the number of opening portions provided in the third outer side surface 23b. In some embodiments, when the opening portion is provided on the first outer side surface 21b and the third outer side surface 23b, the heat insulating member 41 is provided so as not to cover a part where the opening portion is located.

Further, since the heat insulating member 41 is provided as described above, it is possible to effectively suppress the transfer of heat to the power storage stack 101, 103 or the power storage stack 104, 106 when the gas is discharged from the power storage stack 102 or the power storage stack 105. Similarly, when the gas is discharged from the power storage stack 101, 103 or the power storage stack 104, 106, the transfer of heat to the power storage stack 102 or the power storage stack 105 can be effectively suppressed.

In addition, as described above, in the pair of inner wall portions 213A, 213B and the pair of inner wall portions 214A, 214B, the thickness of the outer end portion is larger than the thickness of the inner end portion. This further suppresses the transfer of heat to the power storage stack 101, 103 or the power storage stack 104, 106 when the gas is discharged from the power storage stack 102 or the power storage stack 105. Similarly, when the gas is discharged from the power storage stack 101, 103 or the power storage stack 104, 106, the transfer of heat to the power storage stack 102 or the power storage stack 105 can be further suppressed.

### OTHER VARIATIONS

In the present embodiment, the plurality of unit cells 110 are arranged in the first direction in a state in which the exhaust valves 111 are alternately positioned on one side in the second direction and the other side in the second direction, but the present disclosure is not limited thereto. The plurality of unit cells 110 may be arranged in the first direction with all the exhaust valves 111 facing the partition wall portion 212. In this case, the distance between all the exhaust valves 111 and the opening portion is shortened. Therefore, it is possible to suppress the gas discharged from the exhaust valve 111 being diffused in each region (from the first region 291 to the sixth region 296).

Further, a case in which the plurality of unit cells 110 are arranged in the first direction has been described as an example, but the present disclosure is not limited thereto and may be arranged in the second direction. In this case, the unit cell 110 has a longitudinal shape in which the first direction is the longitudinal direction.

In the above-described embodiment, the number of the respective opening portions 255, 256 is the same as the number of the respective opening portions 251, 252 provided in the first inner side surface 21a on one side in the second direction partitioned by the partition wall portion 212, but the present disclosure is not limited thereto. Here, the respective opening portions 255, 256 are provided on the second inner side surface 22a. The number of the respective opening portions 255, 256 provided in the second inner side surface 22a may be larger than or smaller than the number of the respective opening portions 251, 252 provided in the first inner side surface 21a.

When the number of the respective opening portions 255, 256 is larger than the number of the respective opening portions 251, 252, the gas discharged from the power storage stack 101, 103 can be discharged to the outside more quickly, so that the transfer of heat to the power storage stack 102 can be further reduced.

On the other hand, when the number of the respective opening portions 255, 256 is smaller than the number of the respective opening portions 251, 252, the stiffness of the side wall portion 211A, 211B can be increased.

Also on the other side in the second direction partitioned by the partition wall portion 212, similarly, the number of the opening portions 265, 266 provided in the second inner side surface 22a may be larger or smaller than the number of the opening portions 261, 262 provided in the third inner side surface 23a.

In the above-described embodiment, the opening is not provided in the second outer side surface 22b of the side wall portion 211A, 211B, and the number of the opening portions provided in the second inner side surface 22a is larger than the number of the opening portions provided in the second outer side surface 22b. However, an opening portion may be provided in the second outer side surface 22b. Also in this case, the number of opening portions provided in the second inner side surface 22a may be larger than the number of opening portions provided in the second outer side surface 22b. However, the number of opening portions provided in the second inner side surface 22a may be smaller than the number of opening portions provided in the second outer side surface 22b.

When the number of the opening portions provided in the second inner side surface 22a is smaller than the number of the opening portions provided in the second outer side surface 22b, the gas discharged from the power storage stack 101, 103, 104, 106 can be discharged to the outside of the housing case 120 more quickly.

The embodiments disclosed herein are illustrative and not restrictive in all respects. The scope of the present disclosure is defined by the claims, and includes all modifications within the meaning and range equivalent to the claims.

What is claimed is:

1. A power storage device comprising:
a first power storage stack, a second power storage stack, and a third power storage stack arranged in a first direction; and
a housing case that houses the first power storage stack, the second power storage stack, and the third power storage stack, wherein:
the housing case includes a pair of side wall portions and a pair of inner wall portions, the side wall portions being each located on an end portion side in the first direction, and the inner wall portions being disposed between the side wall portions;
an exhaust path is provided inside each of the side wall portions and the inner wall portions;
the side wall portions include a first side wall portion located on one side in the first direction and a second side wall portion located on another side in the first direction;
the inner wall portions include a first inner wall portion located on the one side in the first direction and a second inner wall portion located on the other side in the first direction;
the first power storage stack is disposed between the first side wall portion and the first inner wall portion;
the second power storage stack is disposed between the inner wall portions;
the third power storage stack is disposed between the second inner wall portion and the second side wall portion;
the first inner wall portion and the second inner wall portion have respective first inner side surfaces that face each other in the first direction and respective first outer side surfaces each located on a side opposite to a side where the first inner side surface is located in the first direction;
each of the first side wall portion and the second side wall portion has a second inner side surface that faces the side wall portions in the first direction; and
an opening portion that communicates with the exhaust path is provided in the first inner side surface of each of the first inner wall portion and the second inner wall portion and in the second inner side surface of each of the first side wall portion and the second side wall portion in which the number of the opening portions is greater than the number of opening portions provided in each of the first outer side surfaces.

2. The power storage device according to claim 1, wherein a heat insulating member is provided on the first outer side surface of each of the first inner wall portion and the second inner wall portion.

3. The power storage device according to claim 1, wherein:
each of the first inner wall portion and the second inner wall portion has an inner end portion located on a side of the first inner side surface in the first direction and an outer end portion located on a side of the first outer side surface;
in the first inner wall portion and the second inner wall portion, the exhaust path is located between the inner end portion and the outer end portion; and
a thickness of the outer end portion in the first direction is greater than a thickness of the inner end portion in the first direction.
